(19) United States
(12) Patent Application Publication
(10) Pub. No.: US 2019/0104689 A1
(43) Pub. Date: Apr. 11, 2019

(54) Universal Wreath Decoration System

(71) Applicant: Robin L. Barnes, Dallas, TX (US)

(72) Inventor: Robin L. Barnes, Dallas, TX (US)

(21) Appl. No.: 16/154,973

(22) Filed: Oct. 9, 2018

Related U.S. Application Data
(60) Provisional application No. 62/570,309, filed on Oct. 10, 2017.

(51) Int. Cl. A01G 5/04

(52) U.S. Cl. CPC A01G 5/04

(57) ABSTRACT

A universal decoration apparatus system comprises decorative elements, such as a floral arrangement, and a base having at least two different attachment mechanisms for attachment of the decoration apparatus to a standard wreath or other substrate without requiring any modification of the wreath. Multiple decoration apparatuses may be used together to achieve different looks or may be swapped out for a change of season or holiday. Wires, clips, magnets, suction cups, and straight pins may be used as base attachment mechanisms to accommodate a variety of different wreath materials and shapes. Unused wires may be tucked away from view and unused clips may be removed. Wires having different characteristics, such as color and gauge, may be selectively used according to the particular wreath base and display conditions. Clips may be selectively positionable at different angles to aid in secure attachment of the decoration apparatus.

### BACKGROUND OF THE INVENTION

### 1. Field of the Invention

This invention relates to removable decorations that are selectively usable with a variety of standard substrates, including any type of wreath, swag, basket, and the like, without requiring any modification of the substrate, and methods of making and using the same.

### 2. Description of Related Art

Decorative wreaths are used to seasonally decorate or decorate for holidays. Such wreaths usually include floral or foliage decorations, bows, and/or figurines that are permanently affixed to the wreath base or substrate by glue. If not glued, these decorations may be secured to the wreath base by wire wrapping around the wreath and the decorations in a manner that is not designed for separation of the decorations from the base by the end user. As result, most users will purchase and have to store multiple wreaths to change out the decorations for the season or holiday, even though the type of wreath base is frequently the same as other wreaths owned by the user. For example, the user may purchase three grapevine wreaths, one decorated for Christmas, one for spring, and one for Valentine's. The user may also purchase two straw wreaths, one decorated for fall and one for Easter. The wreath base (the grapevine or straw structure, for example) accounts for the majority of the size of a decorated wreath and can be 10-36 inches wide (or larger), 10-36 inches long (or longer), and 2-3 inches deep (without decorations). These wreaths take up a lot of storage space, making them difficult to store for both the end user and for retailers who sell them. It is expensive to ship the wreaths from the manufacturer to the retailer or purchaser because of the bulkiness of the wreath base. It is also expensive for the user to purchase so many wreaths, particularly when it results in duplicates of the type of wreath base.

There are also a few wreaths in the prior art that allow for removable and interchangeable decorations. Many of these types of wreaths involve complicated and bulky attachment structures or structures that are only suitable for branch type (such as grapevine or pine bough) wreathes. For example, U.S. Pat. No. 5,513,978 discloses a tapered shape anchor attached to a decoration, such as a pine cone, by wire or string. The anchor is inserted all the way through the wreath base, narrow end first, so that the wider end catches on the branches on the back side of the wreath. The anchor is then visible from the back side of the wreath, which is not desirable for a glass door. Additionally, the anchor adds some bulk to the back of the wreath, which may make the portion of the wreath with the decoration protrude more than other portions without the decoration. Also, this type of mechanism is not useable with a foam or straw type wreath base. Similarly, U.S. Pat. No. 5,789,043 discloses a decoration base with prongs extending from the base. The prongs are inserted through branches on the wreath to hold the decoration base in place. This type of attachment mechanism is also not useable with a foam or straw type wreath.

Other prior art wreaths with removable decorations require specialized wreath bases having apertures or connectors to allow the decorations to be affixed to the wreath and require decorations to completely cover the wreath in order to cover up all the holes or hook and loop tape. For example, U.S. Pat. No. 4,133,922 discloses a wreath base having protruding retaining members that form slots into which a stem of a decoration is inserted. The retaining members are spaced out alone the wreath so that the decorations inserted into one retaining member cover up the next retaining member. Similarly, U.S. Pat. No. 5,110,635 discloses a wreath base made of vines or rods bound together with spirally wound hook and loop tape. Decorations having the corresponding hook or loop tape attached to them are placed onto the spirally wound strip on the wreath base. As another example, U.S. Pat. No. 6,667,079 discloses a wire wreath frame having projecting pins and a box type holder with a plurality of holes to receive decorations. Similarly, U.S. Patent Application Publication No. 2006/0117629 discloses a wire wreath frame with a plurality of grasping clips to attach various decorations. U.S. Pat. No. 7,217,446 discloses a solid wreath base having holes through the wreath. Decorations with rods configured to fit through the holes are inserted into the holes on the wreath base and a fastener secures the rod to the wreath on the backside of the wreath. The fastener may be disguised from view by applying decorations to both sides of the wreath, but that adds to the expense of the wreath and the bulkiness (depth) of the wreath, which may not work for hanging on a door with limited space between the door and a storm or screen door. Additionally, decorations must be placed all around the wreath to cover the holes in the wreath, which does not allow for flexibility in placing a decoration on only one side of the wreath, if desired. U.S. Patent Application Publication No. 2012/0052218 discloses a wreath base having at least one permanently attached (such as by glue) decoration and a coupling device (such as hook and loop tape) located in a predetermined location on the wreath base to which a removable decoration is attachable. The coupling device may also be located on a riser protruding from a predetermined location on the face of the wreath. One of the downsides to this wreath device is that there is a permanently attached decoration, reducing the decorative flexibility of the wreath. Additionally, this attachment mechanism requires the user to place removable decorations in certain predetermined locations (and on all such locations to cover over the coupling device), instead of which ever locations the user desires.

These types of wreaths have added expense in making the wreath base specially designed to connect to the decorations, rather than allowing the use of standard, commercially available wreath bases. They also frequently require the entire wreath base to be covered in decorations to hide the attachment mechanisms on the wreath. This adds to the user's expense of purchasing the decorations and does not allow the user any flexibility in how to decorate the wreath base. For instance, some users prefer a wreath that is only partially covered (such as ¼ or ½ covered) with decorations, leaving some of the wreath visible from the front of the wreath.

Other commercially available removable decorations use elastic or string attached to one side of the decoration that can be wrapped around a standard wreath base and secured to the other side of the decoration with a snap or button. While less complicated than some of the other prior art attachment mechanisms, this type of attachment is not suitable for use with all wreaths. For example, the elastic or string may not be long enough to wrap around a particularly wide wreath. Additionally, if you have a wreath base that has twigs extending outwardly from the inner ring (like a sunburst wreath), the elastic or string would need to be inserted between the twigs to secure the decoration. This may result in breaking the twigs or causing the twigs to separate resulting in an undesirably non-uniform appearance for the wreath base. The elastic or string is also visible from the rear side of the wreath, which is undesirable for use on glass doors where the rear side of the wreath is visible during normal use.

Applicant's own commercially available removable decorations use a combination of two or more wires (of the same type) and two or more alligator type clips spaced apart longitudinally and glued to a base, as shown in FIG. 1. The wires are glued between the decorations and the base or between two base layers, extending outwardly from the sides of the decoration. The alligator clips are permanently affixed to the back side of the decoration base by gluing one of the clip arms to the base. Both the wires and clips are visible from the back side of the decoration. Additionally, the clips are not adjustable, making it more difficult to attach the decoration to a wreath substrate as the clips do not always align with the twigs or branches of the wreath in order to catch and clasp one of the branches or twigs. The clips may also become disengaged from the back of the base overtime as the glued connection between the clip arm and the bottom surface of the base becomes fatigued resulting in failure of the attachment mechanism.

There is a need for a universal decoration attachment that will allow a user to easily and selectively attach one or more separate decorations to any type of standard wreath base without requiring any modification of the wreath base and allowing the user to determine where to place the decorations on the wreath and how much of the wreath base is left visible from the front. There is also a need for a universal decoration that allows for flexibility in the attachment devices and allows non-used attachment devices to be hidden from view or removed.

### SUMMARY OF THE INVENTION

The universal wreath decoration disclosed herein may be added to standard wreath bases or substrates without requiring any specialized wreath base or modification of the wreath base. The decoration allows for flexibility in placement location on the wreath and multiple decorations may be used together on a single wreath, if desired. According to one preferred embodiment of the invention, the wreath decoration comprises a base having a bottom surface and a top surface. A plurality of decorative elements, such as flowers, leaves, and ribbon, are attached to the top surface of the base. Most preferably, the decorative elements are permanently attached to the base and completely cover the base. Most preferably, the decorative elements also extend some distance beyond the perimeter of the base. At least two base attachment mechanisms are connected to or connectable to the base, allowing the base to be removably attached to a wreath. Most preferably, one of the base attachment mechanisms is a wire that may be wrapped around the wreath base and the other base attachment mechanism is a removable alligator-type clip that may be used to grasp branches or vines on a grapevine wreath. According to another preferred embodiment, the wire is attached to the top or upper surface of the base, between the base and decorative elements. According to another preferred embodiment, at least one set of wires is used as a base mechanism, with each wire in a set having at least one characteristic (such as color and/or gauge) different from the other wire or wires in the set. Most preferably, there are a plurality of removable clips spaced out along the longitudinal sides of the base. Most preferably the clips on one side of the base are offset relative to the clips on the other side of the base or an irregular placement pattern is used to provide greater flexibility in having at least two clips align with branches on the wreath for attachment.

According to another preferred embodiment, there are at least three base attachment mechanisms. The third base attachment mechanism is a magnet, suction cup, or straight pin. The magnet and suction cup are particularly useful for attaching the decoration to a metal or glass door without requiring a wreath base, if desired. One or more straight pins are particularly useful for attaching the decoration to a foam or straw wreath base, if desired. According to another preferred embodiment, there are at least two locations on the base for insertion of a pin. Each pin location is in an unobstructed or minimally obstructed area of the base, where there is no other base attachment mechanism that would obstruct insertion of a pin and where there is no glue or stitching, or a minimal amount of glue or stiches, between the decorative elements and the base and between base layers, to make insertion of the pin easier. According to another preferred embodiment, the pin locations are marked on the base or an instructional diagram is provided to indicate where pockets are located.

According to yet another preferred embodiment, the base comprises two layers. In this embodiment, the decorative elements are attached to an upper surface of the upper layer with the wires disposed between the two base layers, preferably glued or otherwise permanently attached between the layers, and at least one other base attachment mechanism (such as the clips, magnet or suction cups) may be permanently attached to or removably attached to a bottom surface of the bottom layer. According to another preferred embodiment, a wire slot is formed between the upper and bottom layers of the base for each wire or wire set. The wire slot is configured to allow the wire or wires in a wire set to be tucked into the slot and hidden from view when not in use. When a wire is used as a base attachment mechanism, the twisted portion (where the wire is connected to itself after wrapping around the wreath) may be tucked into the slot to hide it from view. Additionally, according to another preferred embodiment, the wire used as a base attachment mechanism may be removable from the base and inserted through the wire slot when it is desired to use a wire as a base attachment mechanism.

According to another preferred embodiment, the base comprises a plurality of clip slots and aligned clip pockets, each slot configured to receive an arm of each clip being used. The arm of the clip received in the slot may be permanently affixed in the slot, such as by gluing, or it may remain free, allowing the clip to be removed when not in use. Having an arm of the clip in the clip slot so there is a layer of base between the inner clip arm and the wreath material provides a more secure attachment of the decoration to the wreath substrate as compared having the clip arm glued to the bottom or back side of the base, which may fail after repeated use. When it is desirable to use a clip for attachment of the decoration, the lower arm of the clip is inserted through the clip slot, into a clip pocket disposed between the base and decorative elements in a single layer embodiment or between the two base layers in a two layer embodiment. The clip is actuated to grasp a branch on the wreath, pinching the base and branch together to secure the decoration to the wreath. Preferably at least two clips are used to secure a decoration, but any number of clips may be used as desired and in any configuration (such as one clip through the uppermost right hand side clip slot and one clip through the lowermost left hand side clip slot or through the uppermost and lowermost right hand side clip slots) to be inserted into the clip slot. Most preferably, each clip pocket is disposed at an angle or range of angles relative to an axis that is perpendicular to a line tangential to the side of the base at a point nearest the center of the clip slot opening for the pocket. Most preferably, the clip pockets are arranged along both longitudinal sides of the base in an offset or irregular pattern.

The use of clip slots for the clips in this preferred embodiment also allows for more secure attachment of the clip to the base, when desired. Preferably, clip slots are located near an outer edge of the base and spaced out along the length of the base. Most preferably, slots are located along both longitudinal sides of the base in an offset or other irregular pattern to provide greater flexibility in having at least two clips align with branches on the wreath for attachment. In one preferred embodiment, the arm inserted through the clip slot is glued or otherwise attached to the base within the clip pocket. In a single base layer embodiment, the arm may be glued to the upper surface of the base and then covered with decorative elements. In a two layer embodiment, the clip slot is in the bottom layer and the arm may be glued to the bottom surface of the upper layer and/or the upper surface of the bottom layer. In the attached or removable clip embodiments, the other arm (not inserted through the clip slot) and the actuator of the clip remain free on the bottom surface of the base to allow the clip to be opened for attaching the base to a wreath.

These and other features, objects and advantages of the present invention will become better understood from a consideration of the following detailed description of the preferred embodiments and appended claims in conjunction with the drawings. Although the discussion of the preferred embodiment will focus on use of the decoration with various standard wreath bases, the invention may be used to decorate other substrates, such as a vase, lamp shade, or a Christmas tree, for example, as will be understood by those of ordinary skill in the art.

### BRIEF DESCRIPTION OF THE DRAWINGS

The apparatus of the invention is further described and explained in relation to the following drawings wherein:

FIG. 1 is a bottom plan view of a prior art decoration attachment device;

FIG. 2 is a bottom plan view of one preferred embodiment of the invention;

FIG. 3 is bottom plan view of another preferred embodiment of an apparatus according to the invention;

FIG. 4 is a partial side elevation of the apparatus of FIG. 3;

FIG. 5 is an exploded, partial side elevation of the apparatus of FIG. 3;

FIG. 6 is a partial cross sectional view of the apparatus of FIG. 5 when assembled;

FIG. 7A is a bottom plan view of another preferred embodiment of an apparatus according to the invention;

FIG. 7B is a partial bottom plan view of the apparatus of FIG. 7A having a rectangular base shape and including optional features;

FIG. 7C is a partial bottom plan view of the apparatus of FIG. 7A having a rectangular base shape including optional features;

FIG. 7D is a partial bottom plan view of the apparatus of FIG. 7A having a rectangular base shape including optional features;

FIG. 7E is a partial bottom plan view of the apparatus of FIG. 7A including optional features;

FIG. 8 is a cross sectional view of the apparatus of FIG. 7A.

### DESCRIPTION OF THE PREFERRED EMBODIMENTS

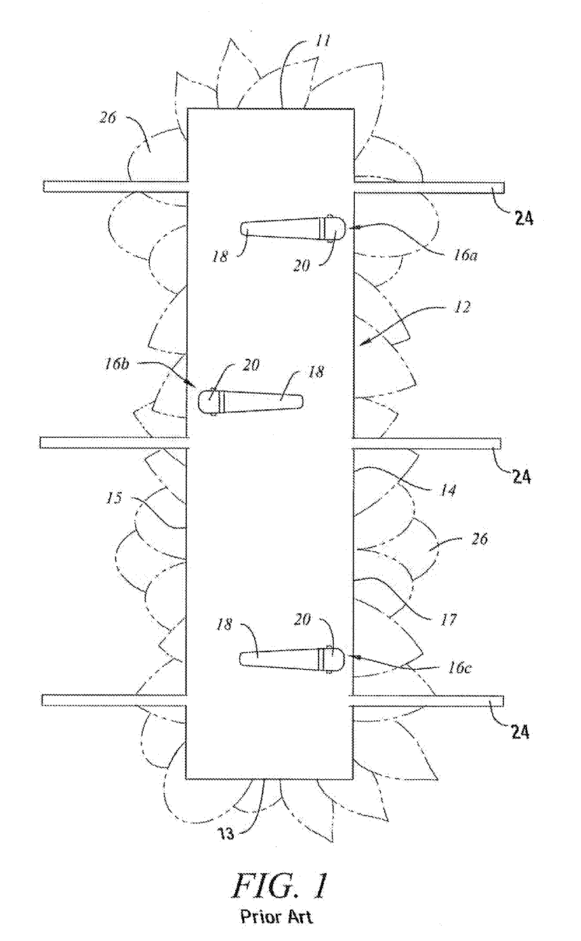

Referring to FIG. 1, a bottom view of a prior art decoration attachment device is shown. The device includes a base 12 having a bottom surface 14 that would contact the forward facing (visible when in use) surface of the wreath base or other substrate to which the decoration is to be attached. The top surface (not shown) of base 12 would contact the bottom surfaces of the decorative floral elements 26. Decorative elements 26 are permanently attached to base 12 using adhesive. Recognizing that all forms of attachment are not permanent in the sense that items may be detached from each other if enough force is applied, as used herein references to “permanent” or “permanently” attached refer to attachments that are secure and not intended for removal or separation, such as attachment by gluing, sewing, or riveting. Attached between base 12 and decorative elements 26, or between two base layers 12, are 2-3 spaced apart wires 24, each wire 34 being the same type and color wire and permanently glued to base 12. The wires extend laterally across base 12 with the ends of the wires 24 extending sufficiently beyond the side edges 15, 17 of base 12 to provide enough length to wrap the wires around the wreath base and twist them together on the back side of the wreath base or other substrate. As a second base attachment mechanism, 203 spaced-apart alligator type clips 16 are permanently glued to a bottom surface of base 12 as a second base attachment mechanism. As both the wires and clips in this prior art decoration attachment device are glued to the base, neither are removable when not in use and both may be visible when attached to a wreath or other substrate. The base on this prior art device does not have pockets or any other mechanism for hiding the wires when not in use.

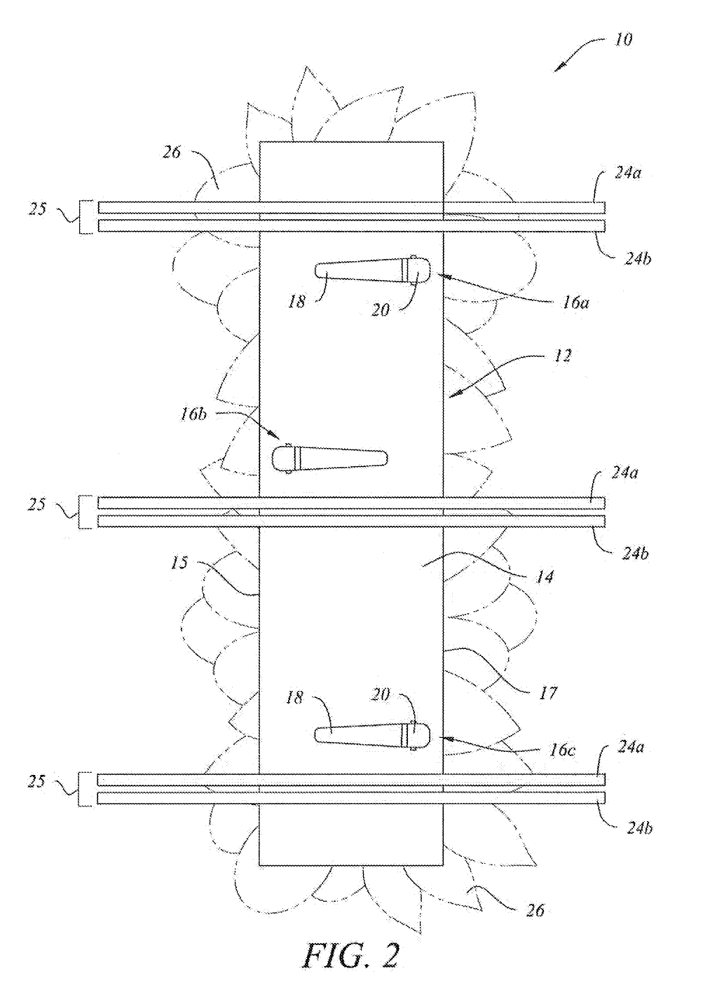

Referring to FIG. 2, a bottom view of a preferred embodiment of a universal wreath decoration apparatus 10 according to the invention is shown. Decoration apparatus 10 comprises a base 12 having a bottom surface 14 that would contact the forward facing (visible when in use) surface of the wreath base or other substrate to which the decoration is to be attached. The top surface (not shown) of base 12 would contact the bottom surfaces of the decorative elements 26, such as floral or foliage arrangements, monogram letters, characters, and/or figurines. Most preferably, decorative elements 26 are permanently attached to base 12 using adhesives, but other attachment mechanisms may also be used, such as sewing or rivets. It is preferred that decorative elements 26 be attached to the top surface of base 12 substantially along the perimeter of base 12 and at one or more locations laterally across base 12. One or more decorative elements 26 combine to form an overall decoration or decorative body having an outer perimeter that is preferably slightly larger than the perimeter of base 12. It is preferred that decorative elements completely cover the top surface of base 12 so that base 12 is not visible from the front of the decoration apparatus 10 when in use.

Base 12 is shown with rectangular shape, that would work well to cover part of a round, oval, square, or rectangular shaped wreath base, but would also work to cover part of any other shaped wreath (such as a heart or star). Other shapes for base 12, such as an arcuate shape may also be used to provide partial coverage of the wreath base. Multiple decoration apparatuses 10 may be used together (end to end, side to side, or any combination thereof) on a single wreath base to provide more coverage or full coverage of the base. Additionally, base 12 may be sized and shaped to provide full coverage of a wreath base (such as a circular, oval, square, rectangular, heart, or other shaped ring, referred to as a “full ring”), if desired, but this is somewhat limiting since the decorative apparatus 10 would be sized and shaped to fit only particular wreaths. Most wreaths come in standard shapes and sizes, so a full ring base 12 could still be used with different wreath bases (a 12 inch round grapevine wreath and a 12 inch round straw wreath, for example). However, it is most preferred for base 12 to have a partial shape to allow greater flexibility with interchangeability of location and orientation of decoration apparatus 10 on the wreath base and allow combinations of decoration apparatuses 10 (with each having the same decorative elements 26 or each having different, preferably coordinating, decorative elements 26) to be used to achieve different looks.

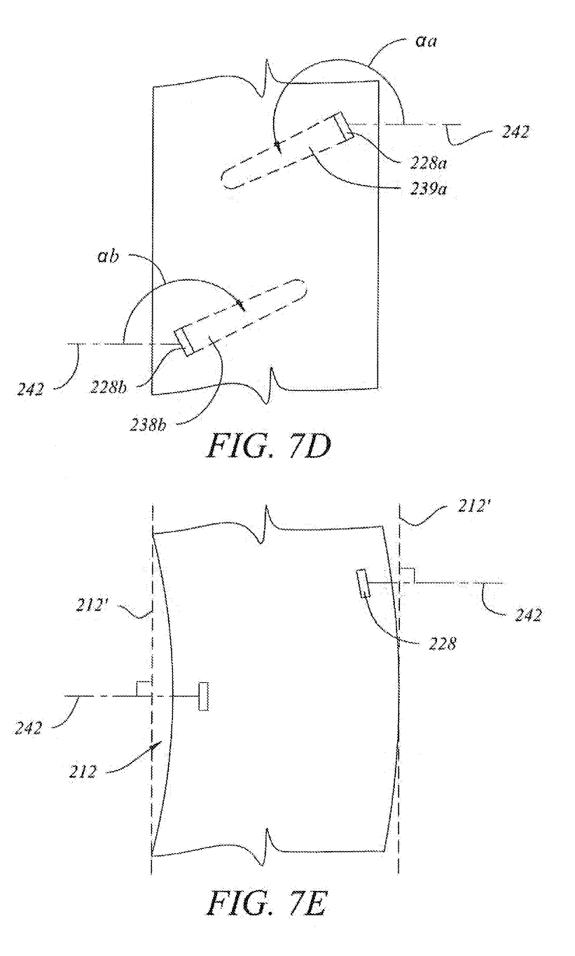

Attached to bottom surface 14 are a plurality of wire sets 25 spaced out along the length of base 12. Each wire set 25 contains at least two wires, 24a and 24b, but additional wires (e.g. a third wire, or third and fourth wires) may also be included in each set 25. Each wire set 25 is spaced out every 3-6 inches along the length of base 12 (or such other entirety of base 12, if base 12 is a full ring). If base 12 is a smaller shape, such as an arc or rectangle, that alone would only partially cover the desired wreath base, a wire 24 (or 124 as shown in FIG. 7A where wire sets 25 are not used) or a wire set 25 is preferably placed near each of the longitudinal ends 11 and 13 of base 12, with additional wires or wire sets being spaced out from the ends. In this preferred embodiment, wires 24a and 24b are preferably permanently attached to surface 14 using adhesives or by sewing. The wires extend laterally across base 12 with the ends of the wires 24a and 24b extending sufficiently beyond the side edges 15, 17 of base 12 to provide enough length to wrap the wires around the wreath base and twist them together on the back side of the wreath base or other substrate. Typically, the wires will extend around 4-8 inches from each side of base 12. According to one preferred embodiment, the wires extend the same distance from each side of the base (the wires being centered on the base). According to another preferred embodiment, the wires on one side of the base extend further than the wires on the other side of the base or the wires alternate in length, one wire being longer on the right side than the left side and the next wire being longer on the left side than the right side. The wires also provide a mechanism for attaching one decorative apparatus 10 to another decorative apparatus 10 to connect them together (particularly to connect them side to side) to form a larger overall decoration as desired. A wire 24 from one decoration apparatus 10 may connect to a wire 24 from another decoration apparatus 10.

Most preferably, in embodiments having wire sets 25, wires 24a have at least one characteristic that is different from wires 24b. The characteristic may be coloration, gauge (strength/thickness), and/or length extending from the sides of base 12. For example, wires 24a may be colored dark brown to coordinate with a grapevine wreath base and wires 24b may be colored light tan or a silver tone to coordinate with or not be very visible against a straw wreath base. Additional colors may also be used for each additional wire in a wire set 25. For example, a third wire could be dark green to coordinate with pine tree foliage on a Christmas wreath base or greenery on a boxwood wreath base. The use of different coloration adds to the flexibility of use for decorative apparatus 10 with substrates of different colors, as the user can select which colored wire is best suited for the particular wreath base or other substrate being used. The other wire(s) can be folded back along surface 14 when not in use. The colored wire 24 that is preferably selected for use in securing decorative apparatus 10 to a wreath base is the one that is camouflaged against the wreath base or substrate and not easily visible against the substrate when in use.

Wires 24a and 24b (and any additional wires in each wire set 25) may also have different strengths or thicknesses to accommodate the weight of decoration apparatus 10 (primarily determined by the weight of the particular decorative elements 26 used) in various end uses. A stronger or thicker wire may be needed to hold a heavy set of decorative elements 26 to a wreath hanging on a door, while a thinner wire of less strength may be need to attach the same set of decorative elements to a table basket because part of the weight of the decorative elements 26 is supported by the surface on which the basket is placed. Different wire lengths may also be provided to accommodate different sizes wreathes or other substrates. Any of the wires 24 that are not being used to attach decorative apparatus 10 to a substrate may be folded in and tucked behind base 12 so they are not readily visible from the front when in use. Any combination of coloration, thickness/strength, and length may be used for the wires in each set 25 and each set 25 need not have the same combination of wires. For example, a first set and third set of wires 25 may each have a green wire 24a and a brown wire 24b of the same thickness, while a second set and fourth set of wires 25 may each have a green wire 24c (not depicted) and brown wire 24d (not depicted) that are thicker than wires 24a and 24b. A fifth set and sixth set of wires 25 may each have a silver wire 24e (not depicted) that are the same thickness as 24a and 24b and a silver wire 24f (not depicted) that are the same thickness as 24c and 24d. Other combinations are also possible.

Although the wires 24 are generally not very noticeable when wrapped around the wreath base if the decorative elements 26 extend beyond the edges of base 12, the user may prefer to not use wires 24 to attach decoration apparatus 10 to wreath base for aesthetic purposes. Additionally, wires 24 may not be the most effective base attachment mechanisms for certain types of substrates. For example, wires 24 may be difficult to use to attach decoration apparatus 10 to a basket portion of a wreath base (such as a metal bucket type door hanger or an oval wreath that is open in the central portion at the top but has a basket portion at the bottom), since the wires 24 are likely not long enough to wrap all the way around the basket portion. If such a wreath is made of grapevine or a wire form, then the wires 24 may be wrapped through the vines or wire form to attach decoration apparatus 10 to the basket portion, but that may be difficult for some users to manipulate. Accordingly, it is preferred to provide at least two different mechanisms, such as wires 24 and clips 16 described below, to selectively attach decoration apparatus 10 to wreath base to facilitate ease of use and to provide different aesthetic options.

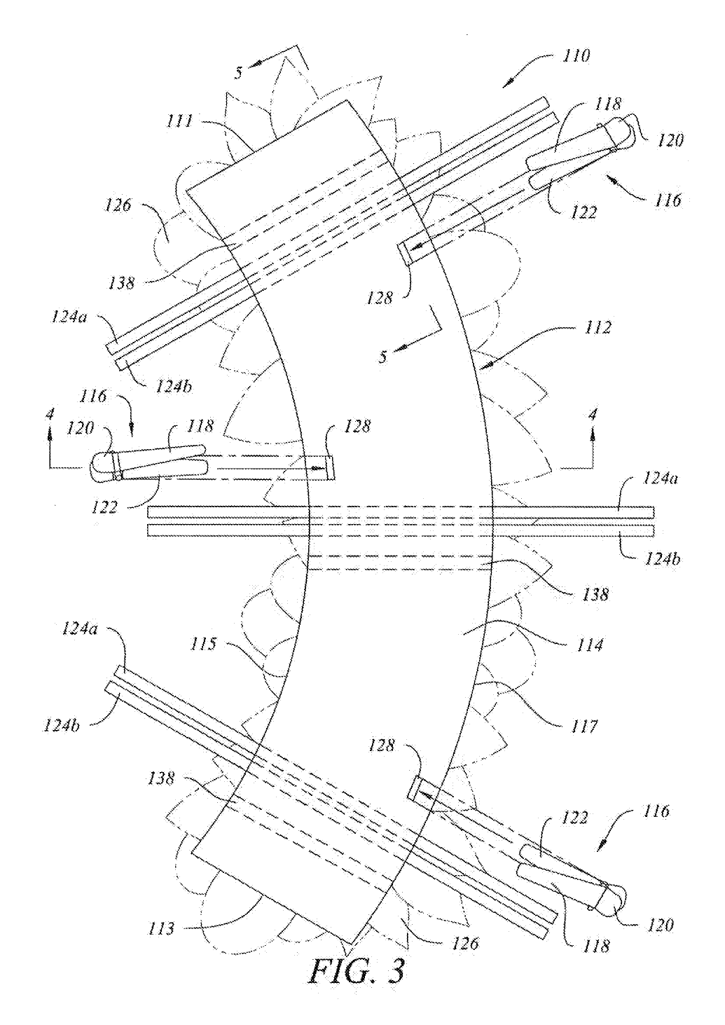

To provide a secondary base attachment mechanism for decoration apparatus 10, a plurality of clips 16 are also attached to bottom surface 14. Clips 16 are most preferably alligator type clips comprising an actuator 20 (usually hinged or spring actuated) with an elongated upper arm 18 and an elongated lower arm (shown as 122 in FIG. 3) forming a mouth to grasp part of the wreath. Either or both upper arm 18 or lower arm (such as 122) preferably have teeth to aid in gripping part of the wreath. Clips 16 are preferably permanently attached to surface 14 by gluing or sewing either the upper arm 18 or lower arm to surface 14. Most preferably, the lower arm is adhered to surface 14, which makes it slightly easier to maneuver actuator 20 than if upper arm 18 is adhered to surface 14. Clips 16 are preferably spaced out every 3-6 inches along the length of base 12 (or such other entirety of base 12, if base 12 is a full ring). Clips 16 preferably alternate orientations with respect to opening direction, with one clip 16a opening toward side 15 and the next clip 16b opening toward side 17, etc. The orientation of any individual clip is not critical, for example 16a could open toward side 17 with clip 16b opening toward side 15. Additionally, two adjacent clips could open toward side 17 and the next clip or pair of adjacent clips could open toward side 15. A clip 16 is most preferably located adjacent each wire 24. Clips 16 are particularly useful in attaching decoration apparatus 10 to a grapevine or wire form wreath base or a wreath base having a basket portion as described above, by inserting upper arm 18 through the vines or wire form to clip decorative apparatus 10 to the wreath base, without having to maneuver wires 24 through the wreath base. Clips may also be used to attach decorative apparatus 10 to the edge of a ribbon on a ribbon-wrapped wreath, to a piece of wire wrapped on the wreath base as part of its standard structure (such as on a straw wreath), or to greenery that is permanently attached to the wreath base (such as a Christmas pine tree wreath or a boxwood wreath), such as floral or foliage arrangements, monogram letters, characters, and/or figurines.

Because of the non-uniform nature of some wreaths, particularly grapevine wreaths, each clip 16 may not be well positioned to grasp part of the wreath base. The alternating nature of the clips 16a, 16b, 16c, etc. aids in ensuring that more than one clip will be able to grasp onto part of the wreath base. It is not required that every clip 16 be used to grasp part of the wreath base in order to securely attach decorative apparatus 10 to the wreath base. When clips 16 are used to secure decorative apparatus 10 to the wreath base, wires 24 may be folded inward onto surface 14 of base 12 to tuck them in behind base 12 and hide them from sight when the wreath is in use. Alternatively, clips 16 and wires 24 may be used in conjunction to provide additional security in the attachment of decorative apparatus 10 to the wreath base. Using both base attachment mechanisms may be particularly useful if the wreath will be used outdoors in unprotected windy conditions.

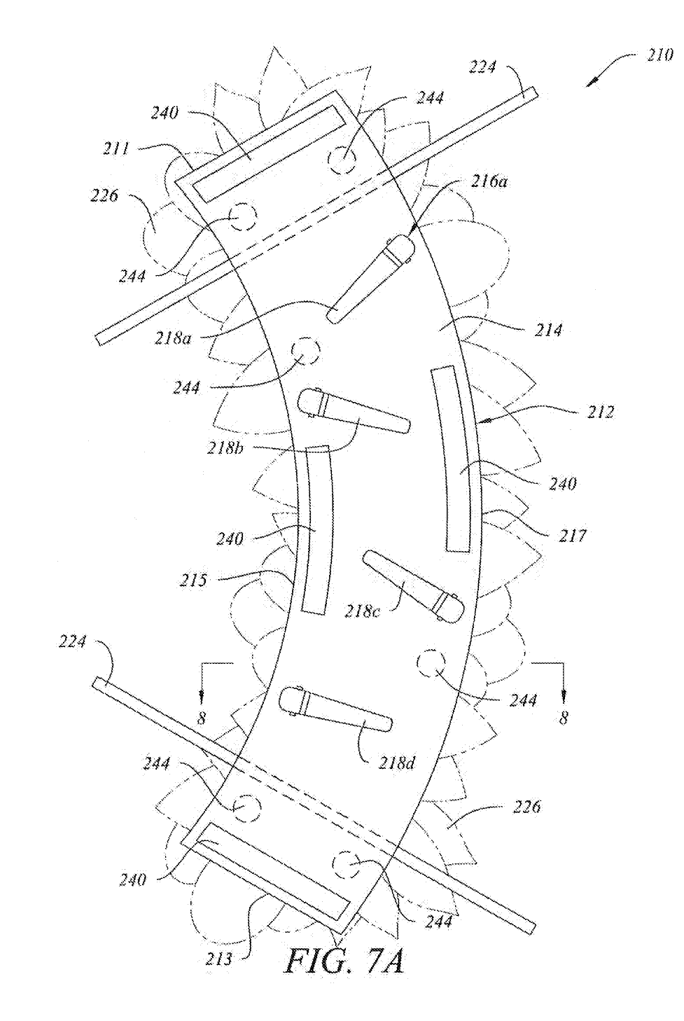

Referring to FIGS. 3-6, another preferred embodiment of a universal wreath decoration apparatus 110 according to the invention is shown. Apparatus 110 comprises a base 112 that is similar to base 12 in FIGS. 1-2, except that in this embodiment, base 112 has an arcuate shape and each set of wires 125 is attached to the upper surface 130 of base 112, rather than the lower surface 114. Each set of wires is disposed between upper surface 130 and the bottom of decorative elements 126. Wire sets 125, and wires 124a, 124b, etc., may have the same variations and configurations as described for wire sets 25 and wires 24a, 24b, etc. to allow selective use of a particular wire or combination of wires to secure decoration apparatus 110 to a wreath base or other substrate. Base 112 also comprises a plurality of wire slots 138, preferably one wire slot 138 for each set of wires 125 and located adjacent to each set of wires 125. Wire slot 138 may be located on either side of a wire set 125 as shown in FIG. 3 (as shown in the drawings, towards the top of the page or towards the bottom of the page relative to a wire set). Wire slot 138 is formed by not attaching decorative elements 126 to upper surface 130. Preferably, the various pieces that make up decorative elements 126 are still adhered to each other in the area over each wire slot 138 to provide structural integrity to the decoration apparatus. Wire slots 138 allow any wires, such as 24a or 24b or both, that are not being used to secure decoration apparatus 110 to a wreath base or other substrate to be tucked into wire slot 138. This allows the unused wires to be hidden from sight from the rear of the wreath or other substrate when is use. Since a portion of surface 114 may be visible from the rear side of the wreath or other substrate when in use, particularly for a wreath hung on a glass door or a basket substrate that is visible from multiple sides, it may be desirable to hide unused wires 124 rather than merely folding them back against surface 114. Wire slots 138 allow unused wires 124 to be hidden between surface 130 and decorative elements 126, so they are not visible from the rear.

According to another preferred embodiment, wires 124 or wire sets 125 may be removable from base 112 and 132. If not permanently attached to base 112 or 132, wires 124 or a selected wire from a wire set 125 may be inserted through any desired wire slot 138, with a portion of the wire extending laterally beyond the sides of the base, to act as a base attachment mechanism for securing apparatus 110 to a substrate.

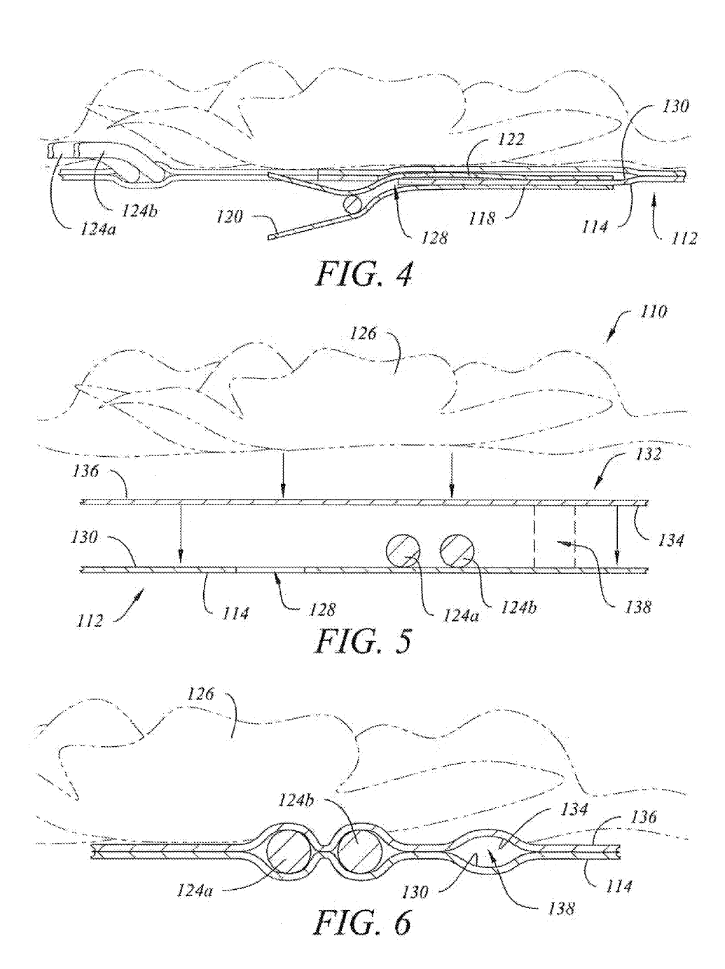

Base 112 also preferably comprises a plurality of clip slots 128, each of which is configured to allow either an upper arm 118 or a lower arm 122 of a clip 116 to pass through the clip slot. Most preferably, lower arm 122 pass through the clip slot 128 and is permanently attached to upper surface 130 of base 112 (and optionally to a bottom surface of decorative elements 126), leaving upper arm 118 free to be opened and closed to provide a secondary mechanism for attaching decoration apparatus 110 to a wreath base or other substrate (as shown in FIG. 4). This disposes lower arm 122 between base 112 and decorative elements 126 to provide additional security and to protect the attachment of clip 116 to base 112. This protection aids in preventing clip 116 from becoming inadvertently detached from base 112 due to wear on the glue or stitches or the like through repeated uses. Clip slots 128 are preferably positioned on alternating sides of base 112 to allow variation in the opening orientation of clips 116, as previously discussed with respect to clips 16. Any configuration of alternating pattern for slits 128 may be used.

In another preferred embodiment, decoration apparatus 110 may optionally comprise a base having two layers, a bottom layer 112 (closest to the wreath base when in use) and an upper layer 132 (closest to decorative elements 126), as shown in FIGS. 4-6. Bottom layer 112 has a bottom surface 114 that would contact the forward facing (visible when in use) surface of the wreath base or other substrate to which the decoration is to be attached and an upper surface 130. Upper layer 132 has an upper surface 136 that contacts the decorative elements 126 and a bottom surface 134. At least a portion of bottom surface 134 is preferably permanently attached to upper surface 130, by gluing, sewing, or riveting. Most preferably, these surfaces are attached along the majority of their perimeters, except for certain portions as discussed below, and attached laterally between sides 115 and 117 in at least one area disposed in a central portion of base 112 between locations for wire sets 125 and clips 116. Layer 132 is preferably substantially the same shape and size as layer 112 and they are preferably made of the same material.

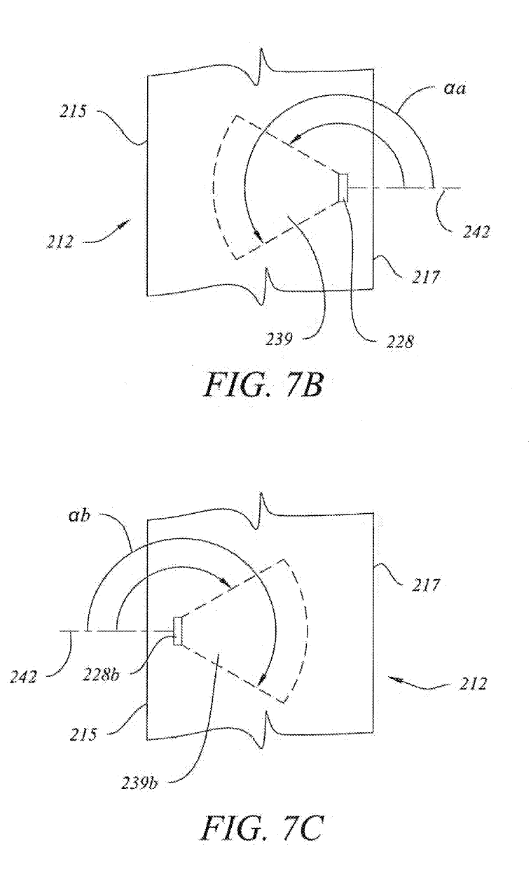

In a two layer embodiment, an arm portion of each clip 116 disposed through each clip slot 128 is preferably permanently attached to either upper surface 130 or lower surface 134 (or both). Clip slots 128 may also be used in a single layer base embodiment, with an arm portion of each clip 116 disposed through a clip slot and attached to the upper surface of the base, the bottom surface of the decorative elements, or both. Also permanently attached to either upper surface 130 or lower surface 134 (or both) in a two layer embodiment, are a plurality of wire sets 125 spaced out along the length of base 112, as previously described. Each wire slot 138 is formed by a gap in the attachment of upper layer 132 and lower layer 112, as shown in FIG. 6. The gap shown in FIG. 6 is exaggerated for illustration purposes. In normal use, layers 112 and 132 would contact each other in the area of each wire slot 138, but would not be adhered or attached together in the area of each wire slot 138. In the two layer embodiment, it is preferred that upper layer 132 and bottom layer 112 be attached together substantially along their perimeters, excluding the area of each wire slot 138 to allow an opening for the unused wires 124 in each wire set 125 to be tucked into the wire slot 138 adjacent to the set. Additionally, it is preferred the perimeter attachment between layers 132 and 112 be set back slightly from the outer perimeter edge. This allows additional room for any unused wires to rest between the layers in the longitudinal area between where the wires 124 are laterally attached to layer 112 and/or layer 132 and the entrance to the adjacent wire slot 138, further hiding the unused wires from sight when decoration apparatus 110 is in use. In another preferred embodiment, wire slots are not used, but the unused wires may still be tucked away from sight in the layer attachment set-back area between the upper and lower base layers near the perimeter edge. Attachment clips 116 may also optionally be removable from decoration apparatus 110, as they are shown separately in FIG. 3 and as further described below with respect to clips 216 in apparatus 210.

According to another preferred embodiment, base layer 132 may comprises a plurality of slots (not shown) through which a portion of decorative elements 126 may be inserted, such as a stem on a floral element. Having a portion of a decorative element 126 between base layers 132 and 112, preferably secured with an adhesive, aids in structural stability and ensuring that decorative elements 126 do not become dislodged from the base, which may happen if they are only attached to an upper surface 136 of base layer 132.

Referring to FIG. 7A, another preferred embodiment of decorative apparatus 210 is depicted. Decorative apparatus 210 preferably comprises a base 212, a plurality of wires 224 (or wire sets, similar to 25, 125), a plurality of clip slots 228 through each of which an arm of a clip 216 is insertable. Most preferable, clips 216 are removable, but an arm of each clip 216 may be permanently attached to bottom surface 214 (in which case, slits 228 are not needed) or to an upper surface of base 112 (similar to upper surface 130). Decorative apparatus 210 preferably comprises a two layer base, similar to apparatus 110, but may also have only a single base layer. The wire, clip, and clip slot configurations for apparatus 210 are essentially the same as with apparatus 10 or 110, with apparatus 210 preferably comprising a plurality of clip pockets 239 or 249, each accommodating insertion of an arm of a removable clip 216.

With a removable clip embodiment, each clip 116 may be selectively inserted into a clip slot 228 when needed as either the only base attachment mechanism used or as a secondary/additional base attachment mechanism, and removed from base 212 when not needed. Having removable clips 216 aids in reducing the bulkiness of decoration apparatus 210 compared to an embodiment where clips are permanently attached to base 212. It also aids in the aesthetics of decorative apparatus 210 when clips 216 are not needed for attachment, since a portion of clips 216 may be visible from the rear or side when in use on a wreath base or other substrate. Removability also adds to the flexibility of use of clips 216, since only as many clips 216 as are needed to secure decoration apparatus 210 to a wreath base or other substrate may be used and only in the particular clip slot 228 locations that are best suited for the particular wreath base/substrate (which may require some trial and error placement by the user to determine the best clip slot 228 locations to grasp portions of the substrate). The removable clip embodiment is most preferably used with a two layer base structure (similar to layers 112, 132), but may also be used with a single base layer (such as base 12). In either of those embodiments, there must be an unobstructed area between the base 12 and decorative elements 26 in a single layer embodiment or between the base layers 112, 132 in a two layer embodiment, where there are no wires or glue/stitches/rivets, etc. that would impede or obstruct insertion of a clip arm.

Most preferably, this unobstructed area is a clip pocket 239 (as shown in dashed lines on FIG. 7D) shaped to receive a clip arm and sized slightly larger than a clip arm (118 or 122). The entry to each pocket 239 is formed by a clip slot 228. Each clip pocket 239a, 239b, etc. is preferably oriented in opposing fashion and clip pockets are located along both sides of base 212 in an offset pattern, but other configurations may also be used, as previously described with the orientation and placement of clips 16 and 116. Preferably, each clip pocket 239 is disposed at an angle α (αₐ, α_{b}, etc.) between about 120° and 240° and more preferably between about 130° and 235° . Most preferably angle α is between about 220° to 230° or between about 130° and 140° , with at least one clip pocket 239 (e.g. 239a) having an angle (e.g. αₐ) in the higher range and at least one other clip pocket 239 (e.g. 239b), preferably oriented in an opposite direction, having an angle (e.g. α_{b}) in the lower range. When base 212 is square or rectangular (as shown as an alternate configuration in FIG. 7D), the angle a is measured from an axis 242 perpendicular to the edge of the base 212 around to a center line of pocket 239, as shown in FIG. 7D. When base 212 is arcuate (as shown in FIGS. 7A and 7E), axis 242 is perpendicular to a line 212′ that is tangential to the curve of base 212 (or a line parallel to a tangential line) and the angle a is measured the same way as shown on FIG. 7D. As will be understood by those of ordinary skill in the art, angle a_{b} may also be measured from axis 242 in the same direction and from the same side as angle αₐ, in which case the angle range for α_{b} (and other α angles for clips oriented to open toward the left side of base (toward side 217, the left side when viewed from front during use) will be between about −60° and 60°, more preferably between −45° and 45°, and most preferably between about −40° to −50° or 40° to 50°.

According to another preferred embodiment, each clip pocket 249 is an arcuate pocket substantially wider than clip arm (as shown in dashed lines on FIGS. 7B and 7C). The entry to each pocket 249 is formed by a clip clot 228. The outer edges 250, 251 of each clip pocket 249 provide a range of angles for insertion of clip arm (118 or 122), so the user can selectively position each clip 216 in each clip pocket 249 at any angle within the range of angles θ formed by outer edges 250 and 251. This allows greater flexibility in placing clip 116a into pocket 249a at any angle within the range of angles θₐ and placing clip 116b into pocket 249b at any angle within the range of angles θ_{b}. The angle of placement for clip 116a may be the same as the angle of placement for clip 116b (and for clips 116c, 116d, etc.) or any one or more clips may be placed at an angle above axis 242 and any one or more other clips at an angle below axis 242, or all clips above or all clips below axis 242. Most preferably the range of angles θ (θₐ, θ_{b}, etc.) is between about 120° and 240° and more preferably between about 135° and 245° and most preferably between 140° and 220°. The angle θ range is measured from an axis 242 (same perpendicular axis previously described) around to outer edge 250 and to outer edge 251 of each pocket 249, as shown in FIGS. 7B and 7C. The use of arcuate pockets 249 provides greater flexibility in the selective placement of clips 216 in order to better grasp a portion of the wreath base or other substrate. However, the wider configuration of arcuate pockets 249 may allow for slippage of a clip 216 along base 212. The arm of clip 216 disposed to contact surface 214 (arm 218 as shown in FIG. 7A) preferably has teeth to aid in reducing such slippage.

Each clip pocket 239 or arcuate pocket 249 is preferably slightly longer than the length of the arm of the clip 216 that is to be inserted into the pocket. As an additional alternative, decoration apparatus 210 may comprise one or more clip pockets 239 and one or more arcuate pockets 249.

Decoration apparatus 210 also preferably comprises at least two magnets or magnetic strips 240 disposed on surface 214 near ends 211 and 213 or near sides 215 and 217. Most preferably, apparatus 210 comprises multiple magnets or magnetic strips 240 disposed on surface 214 at various points around the perimeter of base 212. Magnets 240 may also be disposed on a top surface of base 212, between the base and decorative elements or between base layers in a two layer embodiment. Magnets 240 provide a third base attachment mechanism for decoration apparatus 210, that is particularly useful for attaching apparatus 210 to metal substrates, such as a decorative bucket or a metal door. Magnets may also allow decoration apparatus 210 (or multiple decoration apparatuses 210 combined together) to act as a decoration or even a full ring “wreath” for a metal door without requiring an actual wreath base, in which case the metal door acts as the substrate to which decoration apparatus 210 is attached. For metal doors having a secondary door (screen or storm door) with limited space between the metal door and the secondary door, it may be beneficial to allow use of decoration apparatus as a “wreath” without requiring a grapevine, straw, or other wreath base. Decoration apparatus 210 may also comprise at least two suction cups, spaced out along base 212, in addition to or instead of magnetic strips 240. Suction cups allow decoration apparatus 210 to be attached to a glass door substrate, mirror substrate, or other smooth surface substrate, without requiring a separate wreath base. This may also be beneficial when the glass door has a secondary door (screen or storm door) with limited space between the glass door and the secondary door.

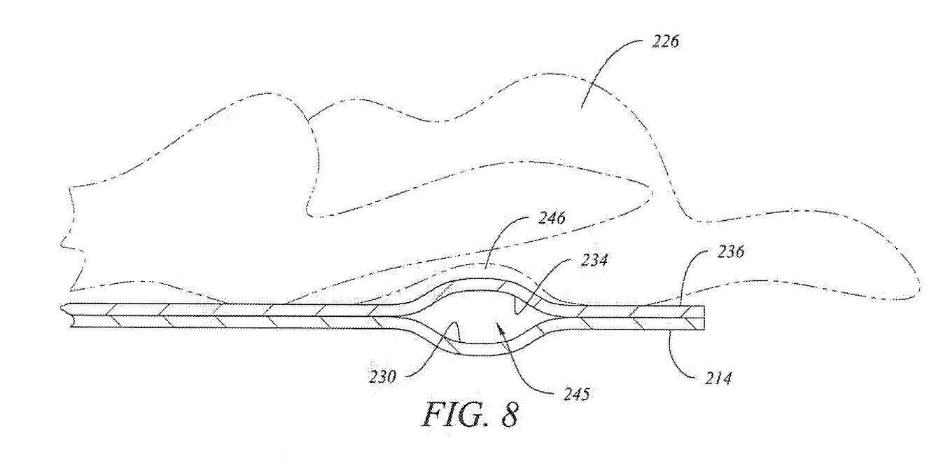

Decoration apparatus 210 also preferably comprises at least two locations 244 for insertion of a straight pin. A straight pin is particularly useful for attachment to straw wreath or foam wreath bases or other penetrable substrates, such as a bulletin board or memory board. Straight pins are preferably separate and removable from apparatus 210. They are preferably inserted from the front side (visible side) of the decorative elements 226 through the base 212 and into the wreath base or substrate, such that the head of the pin is tucked in behind a decorative element 226 and not readily visible when decoration apparatus 210 is in use. Pin locations 244 are most preferably marked spots on surface 214 or on the decorative elements 226 (preferably behind a leaf, petal or other movable portion of the decoration so that the marked spot is not visible in regular use after apparatus 210 is attached to its substrate). Preferably at least one pin location 244 is disposed near end 213 and another disposed near end 211. Most preferably there are several pin locations/marked spots 244 positioned at various points on surface 214 around the perimeter of base 212. Marked spots 244 may be outlined or colored differently than the other portions of surface 214 or decorative elements 226. Alternatively, decoration apparatus may include a separate diagram indicating where on base 212 pin insertion locations 244 are located without actually requiring any physical markings on surface 214 or decorative elements 226. The marked spots 244 indicate an unobstructed or minimally obstructed area 245 and/or 246 as shown on FIG. 8, where it is easier to insert a straight pin through decorative elements 226 and through base 212 (and upper layer 232, if used), to provide a fourth mechanism for attaching decoration apparatus 210 to a wreath base or other substrate. Most preferably, the area for each pin location 244 is an unobstructed area where there is no other attachment mechanism (either a base attachment mechanism or a decoration attachment mechanism as discussed below) that would obstruct insertion of a pin and where there is no glue or stitching between decorative elements and base (or upper base layer) and between base layers that would make insertion of a pin difficult. A pocket 246 may be formed between decorative elements 226 and upper surface 236 of an upper base layer and another pocket 245 formed between lower surface 234 of an upper base layer and upper surface 230 of a lower base layer, as shown as exaggerated openings in FIG. 8. There is no attachment between the layers in the area of pockets 245/246. Similar pockets may be used with a single base layer embodiment.

Alternatively, pin location 244 may be a minimally obstructed area where there is no other attachment mechanism that would obstruct insertion of a pin and where there is a minimal amount of glue or stiches between the layers. Most preferably, in a minimally obstructed embodiment, there is either a pocket 245 or a pocket 246, so that glue or stitching is only between either the decorative elements and upper base layer or between the upper and lower base layers, but not both so that a straight pin may be inserted without much difficulty.

When any pocket or slot (such as 246 or 138) is formed between the base (or an upper base layer) and the decorative elements 26, 126, or 226, it is preferred that the decorative elements still be adhered to each other in the area directly above the pocket or slot to provide structural integrity and to hide the upper surface of either base layer 12, 112, 212 or layer 132, 232, but it is not required that the ornamental elements be attached together in that area, as long as they are sufficiently attached together in the surrounding areas that they will not inadvertently fall off of the decorative apparatus.

Base 12, 112, or 212, and upper layer 132 or 232, are preferably made of fabric, such as felt, burlap, or twill, that is flexible but strong. Other types of fabrics may also be used. A fabric base layer allows for easier penetration by a straight pin, if that is the desired base attachment mechanism. A fabric base layer also allows some flexibility in being able to form the decorative apparatus to the wreath base or other substrate, such as by partially wrapping around the sides or otherwise bending to correspond to the shape of the substrate. A fabric base layer also allows decoration apparatus 10, 110, or 210 to be folded over on itself (such as base layer facing base layer, with the decorative or ornamental elements facing outward) for storage. With traditional decorative wreaths having the decorations permanently attached, they are typically stored by stacking them together (either with or without boxes). This takes up considerable room and the space in the center of the wreath stack is generally unused and wasted. With separate wreath bases and decoration apparatuses according to the invention, storage space is minimized both because fewer wreath bases need to be stored and the decoration apparatuses can be folded and stacked together using the usually wasted space in the center of the wreath bases.

As an alternative to fabric base layers, plastic, metal or wood may also be used for base 12, 112, 212, 132, and/or 232. These alternative base materials provide greater strength and stability, which may be useful for particularly heavy ornamental elements. For any material that is not easily penetrable by a straight pin (e.g. thicker plastic, wood, or metal), base layers preferably comprise a hole in the area of pockets 245 to allow insertion of a straight pin through the decoration apparatus, if desired. It is most preferred that the base materials for two layer bases 112, 132 or 212, 232, be the same for each layer, but different material may also be used for each layer.

Base layers are preferably colored to blend with the main coloration of the ornamental elements, so that if any portion of the base materials is visible during use it will blend with the ornamental elements and not stand out. Alternatively, the base layers may be colored to blend with the main coloration of an intended wreath base or other substrate. For example, a decoration apparatus having Christmas themed ornamental elements may have a dark green colored base (regardless of the colors used for the ornamental elements) to blend with a pine greenery wreath base. Any decoration apparatus according to the invention may also include a separate piece of decorative ribbon or fabric strip designed to be temporarily wrapped around the wreath base or a handle portion of a basket substrate, etc. The ribbon or fabric may be held in place on the wreath base or substrate by overlapping the ends with the decoration apparatus and attaching the decoration apparatus to the wreath base or substrate using any one of or combination of base attachment mechanisms described herein. When a decorative wrapping ribbon or fabric is included, it is preferred that the base layer of decorative apparatus 10, 110, 210 be made from the same material to further aid in camouflaging the base layer.

According to another preferred embodiment, decorative elements (such as elements 26, 126, or 226) are removable from a base (such as base 12, 112, or 212) to which two or more base attachment mechanisms are connected or connectable. In this embodiment, the decorative elements are preferably attached together, such as by sewing or using adhesives, and contain at least one decoration attachment mechanism, and preferably at least two decoration attachment mechanisms, disposed on a rear facing side of the decorative elements. The decoration attachment mechanism is preferably hook and loop tape or snaps that engage with a corresponding side of hook and loop tape or snaps disposed on a front facing side of the base to allow the decorative elements to be removed from the base. This embodiment allows a single base to be reused with different decorations, saving on the costs associated with the base attachment mechanisms (the mechanisms that attach the base to a substrate, such as wires 24, clips 16, magnets 240, and the like). A first decoration attachment mechanism is preferably disposed at least near an upper end of the decorative elements and a second attachment mechanism is preferably disposed near a lower end of the decorative elements with corresponding placement on of the mating attachment mechanisms the base. Other locations, including a centrally disposed location, around the perimeter, or along the sides, may also be used for the decoration attachment mechanisms. The decorative elements may also have a foundation to which the decorative elements are attached on a front or top surface with the decoration attachment mechanism attached to a rear or bottom surface. The base to which the removable decoration elements are attached may include any of the base attachment mechanisms and configurations and may be a two layer base, as previously described with other preferred embodiments of the invention.

The preferred features and optional components of any decoration apparatus, such as embodiments 10, 110 and 210, described herein, such as marked spots 244, arcuate pocket 249, clip pocket 239, two base layer configurations 112, 132, removable clips 216, materials for manufacture, sizes and shapes of bases 12, 112, 212, etc. may be used with any of the embodiments (e.g. 10, 110, or 210) even if not specifically described herein with that particular embodiment.

Although the decoration apparatuses according to the invention may come in a variety of sizes, shapes, and material, and include multiple different attachment mechanisms, the decoration apparatuses are fairly universal for use with all types and sizes of wreath bases and other substrates and do not require the use of specially designed wreath base or any modification to a standard wreath base or other standard substrate. Although primarily described herein for use with standard wreath bases (such as foam, grapevine, cork, wire, branch (e.g. pine branches), and sunburst wreathes), decoration apparatuses according to the invention may also be used with and attached to other types of substrates, including pinning, clipping or wiring to woven baskets, handles of baskets or buckets, bulletin boards, memory boards, lamp shades, vases, or mirrors; pinning, clipping, wiring, or magnetically attaching to magnet boards and metal buckets; magnetically attaching to magnetic appliances (such as refrigerators) and metal doors. The decoration apparatuses according to the invention are reusable on different substrates and allow for easily changing the type of decoration used to fit the holiday or season. The decoration apparatuses according to the invention include various components, configurations, and orientations that allow for multiple attachment mechanisms designed to be suitable with a wide variety of substrates. Preferably at least one attachment mechanism is configured to allow the decoration apparatus to be attached to at least two different types of substrates and most preferably at least two attachment mechanisms are each configured to allow the decoration apparatus to be attached to two different substrates, to provide greater flexibility in the types of substrates that may be used. For example, wires may be used to attach the decoration apparatus to the handle of a basket, to a grapevine wreath, and a foam wreath. Clips may be also used to attach the decoration apparatus to the handle of a basket and the grapevine wreath, but would not be very useful for attachment to most foam wreaths. Clips may also be used to attach the decoration apparatus to a vase or lamp shade. Straight pins may be used to attach the decoration apparatus to a foam wreath, lamp shade, or bulletin board, but would not be very useful for attachment to most grapevine wreathes.

Directional references to front, top, upper, rear, bottom, lower, right, and left herein generally refer to the viewing direction when the decoration apparatus is in use, with the ornamental elements being disposed in the front or top and the base layer, wires, and clips being disposed toward the rear or bottom nearest the substrate. Those of ordinary skill in the art will also appreciate upon reading this specification and the description of preferred embodiments herein that modifications and alterations to the apparatus may be made within the scope of the invention and it is intended that the scope of the invention disclosed herein be limited only by the broadest interpretation of the appended claims to which the inventors are legally entitled.

I claim:

1. A decoration apparatus comprising:
a base having an upper surface and a lower surface;
one or more decorative elements attached to the upper surface of the base;
a first base attachment mechanism;
a second base attachment mechanism different from the first base attachment mechanism;
wherein one or both base attachment mechanisms are configured to removably attach the decoration apparatus to any selected position on a substrate; and
wherein the first base attachment mechanism is removable from the apparatus, or the second base attachment mechanism is configured to be hidden when not in use so it is not visible from a rear side of the decoration apparatus, or both.

2. The decoration apparatus according to claim 1 wherein the substrate is a standard commercially available wreath and no modification of the wreath is required to attach the decoration apparatus to the wreath using at least one of the first or second base attachment mechanisms at any desired location on the wreath.

3. The decoration apparatus according to claim 1 wherein the first base attachment mechanism is a plurality of clips, at least two of which are spaced apart from each other along the base and the second base attachment mechanism is a plurality of wires, at least two of which are space apart from each other along the base.

4. The decoration apparatus according to claim 3 wherein at least one clip is disposed to open toward a right side of the base and at least one other clip is disposed to open toward a left side of the base.

5. The decoration apparatus according to claim 4 wherein at least one clip is disposed at a first angle and at least one other clip is disposed at a second angle, the first angle being different from the second angle.

6. The decoration apparatus according to claim 3 further comprising a clip slot for each clip, each clip slot disposed through the base and configured to receive an arm of the clip.

7. The decoration apparatus according to claim 6 wherein each clip is selectively positionable in any one of the clip slots as needed to achieve a secure attachment to a portion of the wreath.

8. The decoration apparatus according to claim 7 further comprising a clip pocket for each clip slot, each clip pocket providing an area for selective positioning of the clip inserted into the pocket to dispose the clip at an angle.

9. The decoration apparatus according to claim 8 wherein the angle is between about 120° and 240°.

10. The decoration apparatus according to claim 3 wherein the second base attachment mechanism is a plurality of wire sets, each set comprising a first wire and a second wire; and
wherein each first wire is different from each second wire in coloration, gauge, length, or any combination thereof.

11. The decoration apparatus according to claim 10 further comprising a wire slot for each set of wires, each wire slot configured to allow insertion of unused wires to hide them from view during use of the apparatus.

12. The decoration apparatus according to claim 3 further comprising a wire slot for each wire, each wire slot configured to allow insertion of at least one unused wire so the unused wire is not visible from a rear side of the decoration apparatus.

13. The decoration apparatus according to claim 3 further comprising a plurality of pin locations disposed along the base, each pin location configured to allow insertion of a straight pin through at least a portion of the decorative elements and the base as a third base attachment mechanism.

14. The decoration apparatus according to claim 13 wherein each pin location is marked on the base or on the decorative elements.

15. The decoration apparatus according to claim 1 wherein the apparatus is removably attachable to more than one type of substrate and wherein the first base attachment mechanism is configured to attach the apparatus to at least one type of substrate and the second base attachment mechanism is configured to attach the apparatus to at least one other type of substrate.

16. The decoration apparatus according to claim 15 wherein a first type of substrate is a glass door or window and the first base attachment mechanism is a plurality of suction cups disposed on the base

17. The decoration apparatus according to claim 16 wherein a second type of substrate is a metal door and the second base attachment mechanism is a plurality of magnets disposed on a rear surface of the base or between the base and the decorative elements.

18. The decoration apparatus according to claim 16 wherein a second type of substrate is a standard commercially available wreath or basket and the second base attachment mechanism is a plurality of wires disposed on the base or between the base and decorative elements.

19. The decoration apparatus according to claim 18 further comprising a plurality of removable clips or clips permanently attached to the base as a third base attachment mechanism for attachment of the apparatus to the wreath or basket.

20. The decoration apparatus according to claim 15 wherein at least one base attachment mechanism is configured to attach the apparatus to at least two different types of substrates and wherein the types of substrates comprise a foam wreath, a cork wreath, a grapevine wreath, a branch wreath, a wire wreath, a bulletin board, a vase, a basket, a bucket, a metal door, a glass door, a window boards, a lamp shade, a mirror; a magnet board, or a magnetic appliance.

21. The decoration apparatus according to claim 1 further comprising:
a first portion of at least one decoration attachment mechanism disposed on a bottom surface of the decorative element; and
a second portion of the at least one decoration attachment mechanism disposed on the upper surface of the base, the first and second portions configured to engage with each other to removably attach the decorative element to the base.

22. The decoration apparatus according to claim 21 wherein the decoration attachment mechanism is hook and loop tape or snaps.

23. The decoration apparatus according to claim 21 further comprising at least two decorative elements, a first decorative element corresponding to a first season or holiday and a second decorative element corresponding to a second season or holiday, the first and second decorative elements each having the first portion of the decoration attachment mechanism to allow the first or second decorative elements to be selectively attachable to the base.

24. The decoration apparatus according to claim 1 further comprising at least two decorative elements, a first decorative element attached to a first base and a second decorative element attached to a second base, each base having the first and second base attachment mechanisms, and wherein the first and second decorative elements are configured to be used together on a single substrate.

25. A method of making a reusable decoration apparatus, the method comprising:
attaching at least one decorative element to an upper surface of a base;
attaching a first base attachment mechanism to the base;
attaching a second base attachment mechanism to the base, the second base attachment mechanism being different from the first base attachment mechanism;
wherein one or both base attachment mechanisms are configured to removably attach the reusable decoration apparatus to any selected position on a substrate; and
wherein the first base attachment mechanism is removable from the apparatus, or the second base attachment mechanism is configured to be hidden within an opening disposed between the decoration elements and the base when not in use, or both.

26. The method of claim 25 wherein the first base attachment mechanism is at least two clips spaced apart from each other along the base, the method further comprising:
cutting a slot in the base for each clip, each slot configured to receive an arm of the clip with the other arm of the clip disposed on a rear side of the base to engage the substrate.

27. The method of claim 26 further comprising inserting an arm of each clip into each slot and permanently attaching the inserted arm to the decorative element or the base or both.

28. The method of claim 26 wherein the clips are removable from the base and the method further comprises providing a pocket disposed between the decorative element and base for each slot, each pocket configured to allow the arm of the clip inserted through its corresponding slot to be selectively positioned at an angle relative to the slot.

29. The method of claim 26 wherein the second base attachment mechanism is a plurality of wires, at least two of which are space apart from each other along the base and an end of each wire extending laterally beyond a side edge of the base, the method further comprising:
providing at least one opening for each wire, each opening between the decorative element and base and configured to receive the laterally extending ends of any wire not used in attaching the reusable decoration apparatus to a substrate.

30. The method of claim 29 further comprising attaching a third base attachment mechanism to the base, the third base attachment mechanism being a magnet or a suction cup.

31. A method of decorating a substrate, the method comprising:
providing at least one reusable decoration apparatus, each decoration apparatus comprising a decorative element attached to a base having at least two different base attachment mechanisms, wherein at least a first base attachment mechanism is configured to allow the decoration apparatus to be attached to a first type of substrate and the second base attachment mechanism is configured to allow the decoration apparatus to be attached to the first type of substrate or a second type of substrate or both, and wherein one of the attachment mechanisms is configured to be removable from the base or hidden by the base when not in use to attach the decoration apparatus to the substrate;
providing the substrate;
selectively positioning the decoration apparatus on the substrate; and
if the substrate is the first type of substrate, (1) attaching the decoration apparatus to the substrate using the first base attachment mechanism and optionally the second base attachment mechanism or (2) attaching the decoration apparatus to the substrate using the first base attachment mechanism and optionally removing or hiding the second base attachment mechanism; or
if the substrate is the second type of substrate, attaching the decoration apparatus to the substrate using the second base attachment mechanism and optionally removing or hiding the first base attachment mechanism.

32. The method of claim 31 wherein the first and second types of substrates are selected from the group consisting of a foam wreath, a cork wreath, a grapevine wreath, a branch wreath, a wire wreath, a bulletin board, a vase, a basket, a bucket, a metal door, a glass door, a window boards, a lamp shade, a mirror; a magnet board, or a magnetic appliance and wherein no modification of the substrate is needed to attach the decorative apparatus.

33. The method of claim 31 wherein the decorative element of a first decorative apparatus corresponds to a first holiday or first season and the decorative element of a second decorative apparatus corresponds to a second season or holiday, the method further comprising:
removing the first decorative apparatus from the substrate at the end of the holiday or season;
repeating the selectively positioning and attaching steps with the second decorative apparatus at the beginning of the second holiday or season to attach the second decorative apparatus to the same substrate to which the first decorative apparatus was attached.
